(19) United States
(12) Patent Application Publication
(10) Pub. No.: US 2024/0411373 A1
(43) Pub. Date: Dec. 12, 2024

(54) USER INTERFACE DEVICE, AND TACTILE SENSATION EXHIBITING ARTICLE

(71) Applicant: KABUSHIKI KAISHA TOKAI RIKA DENKI SEISAKUSHO, Aichi (JP)

(72) Inventors: Toshiki HARA, Aichi (JP); Takayasu MUTO, Aichi (JP); Kenichiro NAKANE, Aichi (JP); Sotaro YOSHIHARA, Aichi (JP); Daiki KOJIMA, Aichi (JP)

(73) Assignee: KABUSHIKI KAISHA TOKAI RIKA DENKI SEISAKUSHO, Aichi (JP)

(21) Appl. No.: 18/698,126

(22) PCT Filed: Sep. 28, 2022
(86) PCT No.: PCT/JP2022/036256

§ 371 Date: Apr. 3, 2024

(30) Foreign Application Priority Data
Oct. 6, 2021 (JP) 2021-164877

(51) Int. Cl. G06F 3/01; B60K 35/21; G06F 3/044

(52) U.S. Cl. CPC G06F 3/016; B60K 35/21; G06F 3/044

(57) ABSTRACT

An operation accepting member includes a first area and a second area. A detector is configured to detect an operation of a user involving contact with respect to the operation accepting member. At least one of a concave portion and a convex portion configured to provide first tactile sensation to the user is formed in the first area. The second area is configured to provide second tactile sensation that is different from the first tactile sensation to the user. An appearance of the first area and an appearance of the second area are the same when viewed from the same direction.

### FIELD

The presently disclosed subject matter relates to a user interface device configured to accept an operation involving contact. The presently disclosed subject matter also relates to an article having a structure capable of exhibiting multiple types of tactile sensations.

### BACKGROUND

Japanese Patent Publication No. 2020-189613A discloses a touch panel device as an example of the user interface device. The touch panel device includes a surface configured to accept a touch operation performed by a user. The touch panel device is configured to transmit vibration to the user when the surface accepts a touch operation of the user. As a result, the user can obtain a feeling of operation input.

### SUMMARY OF THE INVENTION

### Technical Problem

It is demanded to enhance the convenience of an article capable of exhibiting multiple types of tactile sensations.

### Solution to Problem

An illustrative aspect of the presently disclosed subject matter provides a user interface device, comprising:
an operation accepting member including a first area and a second area; and
a detector configured to detect an operation of a user involving contact with respect to the operation accepting member;
wherein at least one of a concave portion and a convex portion configured to provide first tactile sensation to the user is formed in the first area;
wherein the second area is configured to provide second tactile sensation that is different from the first tactile sensation to the user; and
wherein an appearance of the first area and an appearance of the second area are the same when viewed from the same direction.

An illustrative aspect of the presently disclosed subject matter provides a tactile sensation exhibiting article, comprising:
a first area in which at least one of a concave portion and a convex portion configured to provide first tactile sensation to a user is formed; and
a second area in which at least one of a concave portion and a convex portion configured to provide second tactile sensation that is different from the first tactile sensation to the user is formed,
wherein an appearance of the first area and an appearance of the second area are the same when viewed from the same direction.

For example, the first area and the second area may be associated with different attributes. With the configuration according to each of the above aspects, a user who touches at least one of the first area and the second area with a finger, for example, can recognize the attribute through difference in the tactile sensation without visual confirmation. On the other hand, since the first area and the second area have the same appearance when viewed from the same direction, it is possible to provide a seamless appearance without involving disorder feeling although the structure can provide different tactile sensations. Accordingly, it is possible to enhance the convenience of an article capable of exhibiting multiple types of tactile sensations.

### BRIEF DESCRIPTION OF DRAWINGS

FIG. 1 illustrates a vehicle in which a user interface device according to one embodiment is to be installed.

FIG. 2 illustrates a functional configuration of the user interface device of FIG. 1.

FIG. 3 illustrates one exemplary appearance of an operation accepting member of FIG. 2.

FIG. 4 illustrates a cross section viewed from an arrowed direction along a line IV-IV of FIG. 3.

FIG. 5 illustrates another exemplary appearance of the operation accepting member of FIG. 2.

FIG. 6 illustrates a cross section viewed from an arrowed direction along a line VI-VI of FIG. 5.

FIG. 7 illustrates another exemplary appearance of the operation accepting member of FIG. 2.

FIG. 8 illustrates a cross section viewed from an arrowed direction along a line VIII-VIII of FIG. 7.

FIG. 9 illustrates another exemplary appearance of the operation accepting member of FIG. 2.

FIG. 10 illustrates a cross section viewed from an arrowed direction along a line X-X of FIG. 9.

FIG. 11 illustrates another exemplary appearance of the operation accepting member of FIG. 2.

FIG. 12 illustrates a cross section viewed from an arrowed direction along a line XII-XII of FIG. 11.

### DESCRIPTION OF EMBODIMENTS

Exemplary embodiments will be described in detail below with reference to the accompanying drawings. In each of the drawings used in the following description, the scale is appropriately changed in order to make each item have a recognizable size.

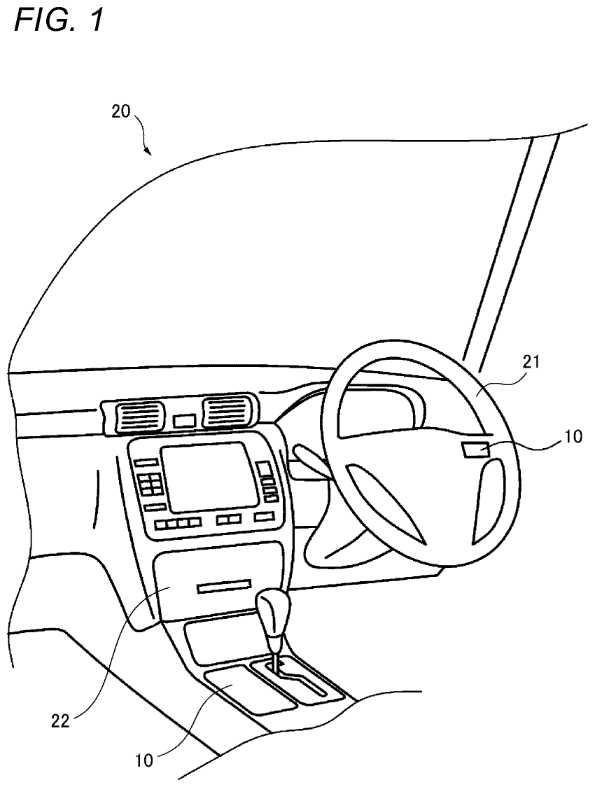

As illustrated in FIG. 1, a user interface device 10 according to an embodiment is configured to be installed in a vehicle 20. For example, the user interface device 10 may be disposed on a steering wheel 21 or a center cluster 22 in a vehicle cabin of the vehicle 20. The vehicle 20 is an example of a mobility.

The user interface device 10 is configured to accept an operation performed by an occupant of the vehicle 20, and to remotely operate a controlled device installed in the vehicle 20 based on the operation. Examples of the controlled device include an air conditioner, a lighting device, an audio-visual equipment, a power-window driving device, and a seat device. The occupant of the vehicle 20 is an example of a user.

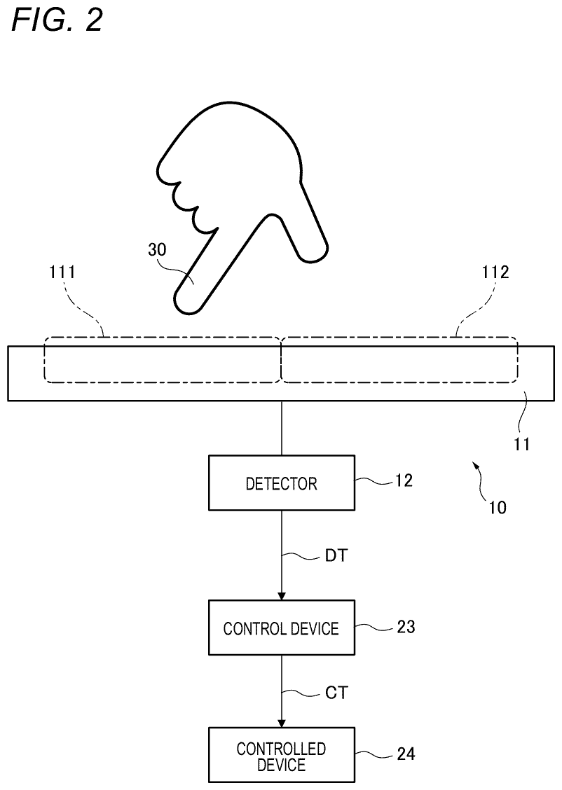

As illustrated in FIG. 2, the user interface device 10 includes an operation accepting member 11. In the present embodiment, the operation accepting member 11 is provided as a part of a touch panel device. The operation accepting member 11 is configured to accept a touch operation performed with a finger 30 of the occupant of the vehicle 20. The touch operation is an example of an operation involving contact. The operation accepting member 11 is an example of a tactile sensation exhibiting article.

The user interface device 10 includes a detector 12. The detector 12 is configured to detect a touch operation with respect to the operation accepting member 11. The detector 12 includes an electrode (not illustrated). The detector 12 is configured to detect an electrostatic capacitance between the operation accepting member 11 and the electrode, and to output a detection signal DT corresponding to the detected electrostatic capacitance.

A control device 23 and a controlled device 24 are installed in the vehicle 20. The control device 23 is configured to control the operation of the controlled device 24 based on the detection signal DT outputted from the detector 12.

Specifically, a current supplied to the electrode from a power source (not illustrated) generates an electric field around the operation accepting member 11. As the finger 30 approaches this electric field, a pseudo capacitor is formed between the electrode and the finger 30. As a result, the electrostatic capacitance between the electrode and the operation accepting member 11 is increased.

The control device 23 may be configured to determine that the contact operation with the finger 30) is performed when a difference between a value of the electrostatic capacitance indicated by the detection signal DT and a reference value exceeds a threshold range, and to output a control signal CT for controlling the operation of the controlled device 24.

The control device 23 may be implemented by a non-exclusive microprocessor configured to cooperate with a non-exclusive memory: Examples of the non-exclusive microprocessor include a CPU, an MPU, and a GPU. Examples of the non-exclusive memory include a ROM and a RAM. In this case, a computer program for executing the above-described processing can be stored in the ROM. The non-exclusive microprocessor designates at least a part of the program stored in the ROM, loads the program on the RAM, and executes the processing described above in cooperation with the RAM.

The control device 23 may be implemented by an exclusive integrated circuit capable of executing the above-described computer program, such as a microcontroller, an ASIC, and an FPGA. In this case, the above-described computer program is pre-installed in a memory element included in the exclusive integrated circuit. The control device 23 may also be implemented by a combination of a non-exclusive microprocessor and an exclusive integrated circuit.

The control device 23 may be disposed at an appropriate location in the vehicle 20 as a device independent of the user interface device 10, or may be incorporated in the user interface device 10.

The operation accepting member 11 includes a first area 111 and a second area 112. The first area 111 and the second area 112 are adjacently arranged.

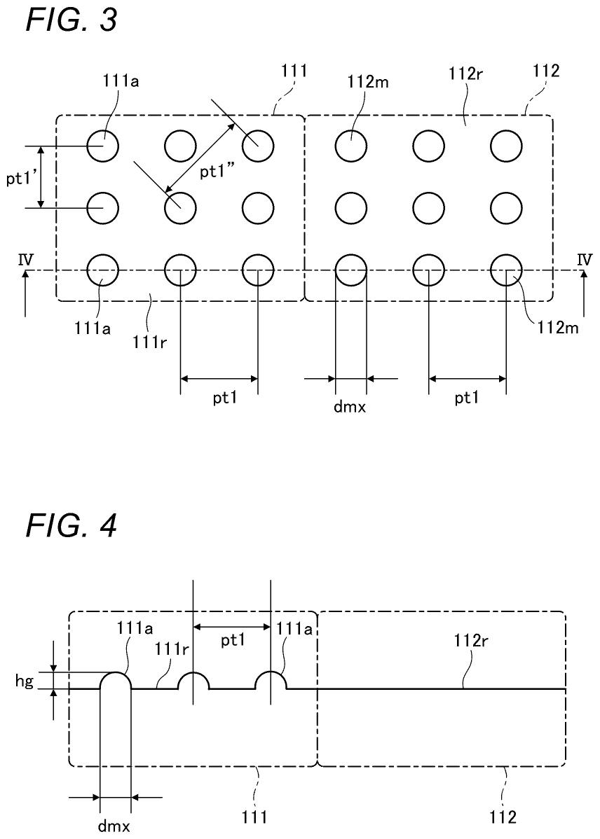

FIG. 3 illustrates, in an enlarged manner, an appearance of a part of the operation accepting member 11 as viewed from the normal direction thereof. FIG. 4 illustrates a cross-section viewed from an arrowed direction along the line IV-IV in FIG. 3.

Multiple convex portions 111a are formed in the first area 111. Each of the convex portions 111a exhibits a hemispherical shape. The convex portion 111a forms a surface of the operation accepting member 11 together with a first reference surface 111r. The convex portion 111a is a portion protruding from the first reference surface 111r.

According to the formation of the multiple convex portions 111a, when the occupant touches the first area 111 with the finger 30, a first tactile sensation is obtained. In other words, the multiple convex portions 111a are so formed as to provide the first tactile sensation to the occupant touching the first area 111.

In accordance with the first tactile sensation to be provided, it is determined at least one of a maximum diameter dmx of the convex portion 111a, a protruded height hg of the convex portion 111a, and an arrangement pitch pt1 of the multiple convex portions 111a. Each of the maximum diameter dmx, the protruded height hg, and the arrangement pitch pt1 is an example of a shape parameter. The arrangement pitch pt1 is defined in a case where three or more convex portions 111a are arranged at equal intervals. The arrangement pitch pt1 is defined as a length of a straight line extending in a direction orthogonal to the normal direction of the first area 111 connecting characteristic points of two adjacent convex portions 111a. In the example illustrated in FIG. 3, the center of the convex portion 111a viewed from the normal direction is determined as the characteristic point.

In a case where the multiple convex portions 111a are arranged two-dimensionally in the first area 111, two or more arrangement pitches can be defined. For example, the arrangement pitch pt1′ defined for at least three convex portions 111a arranged in the up-down direction of FIG. 3 and the arrangement pitch pt1″ defined for at least three convex portions 111a arranged obliquely are different from the above-described arrangement pitch pt1.

In addition, the arrangement pitch does not have to be defined for at least three convex portions 111a linearly arranged. For example, in a case where at least three convex portions 111a are arranged annularly, an arrangement pitch can be defined in the circumferential direction.

The multiple convex portions 111a are not required to be arranged at equal intervals in a specific direction. In other words, an interval between two convex portions 111a arbitrarily selected from the multiple convex portions 111a arranged in a specific direction can have two or more values.

A value of the maximum diameter dmx may fall within a range from 0.05 mm to 25 mm. A value of the protruded height hg may fall within a range from 0.02 mm to 1 mm. A value of the arrangement pitch pt1 may fall within a range from 0.05 mm to 25 mm. It should be noted that the diameter dmx must be smaller than the arrangement pitch pt1.

At least one of a ratio pr1 of the protruded height hg to the maximum diameter dmx, a ratio pr2 of the arrangement pitch pt1 to the maximum diameter dmx, and a ratio pr3 of the arrangement pitch pt1 to the protruded height hg may be used as a reference in determining the first tactile sensation.

A value of the ratio pr1 may fall within a range from 0.0008 to 20. A value of the ratio pr2 may fall within a range from 0.002 to 500. A value of the ratio pr3 may fall within a range from 0.05 to 1250.

As illustrated in FIG. 4, the second area 112 has only a flat second reference surface 112r, that is, no convex portion is formed. Accordingly, when the occupant touches the second area 112 with the finger 30, a second tactile sensation different from the first tactile sensation is obtained. In other words, the second area 112 is configured to provide the second tactile sensation to the occupant touching the area.

On the other hand, as illustrated in FIG. 3, the appearance of the second area 112 when viewed from the normal direction of the second reference surface 112r is the same as the appearance of the first area 111 when viewed from the normal direction of the first reference surface 111r. The normal direction of the first reference surface 111r and the normal direction of the second reference surface 112r to the second area 112 are examples of the same direction. As used herein, the expression “the same appearance” is meant to include a state where the appearances are similar but indistinguishable when viewed from a distance and an angle at which an occupant normally uses the user interface device 10. The expression does not require a perfect match in microscopic appearance. It should be noted that, as long as the appearances of the first area 111 and the second area 112 are the same, the entire part of the operation accepting member 11 does not have to exhibit the same appearance.

Specifically, multiple patterns 112m are formed on the second reference surface 112r of the second area 112. The shape of each pattern 112m has the same shape as the shape of the convex portion 111a when viewed from the normal direction of the first area 111. In other words, each pattern 112m has a diameter corresponding to the maximum diameter dmx. The arrangement pitch of the multiple patterns 112m matches the arrangement pitch pt1 of the multiple convex portions 111a.

The first area 111 and the second area 112 may be associated with different attributes. As an example, the first area 111 and the second area 112 may be associated with an area capable of accepting a touch operation and an area not capable of accepting the touch operation. As another example, the first area 111 and the second area 112 may be associated with areas capable of accepting operations for activating different functions. In this case, an occupant who touches at least one of the first area 111 and the second area 112 with the finger 30 can recognize the attribute through difference in the tactile sensation without visual confirmation. On the other hand, since the first area 111 and the second area 112 have the same appearance when viewed from the same direction, it is possible to provide a seamless appearance without involving disorder feeling although the structure can provide different tactile sensations. Accordingly, it is possible to enhance the convenience of the user interface device 10 for accepting an operation involving contact.

The above advantage is particularly remarkable in a case where the operation accepting member 11 is provided as a part of the touch panel device. A mechanical switch device is generally provided with a boundary structure dividing an area that is capable of accepting an operation involving contact and an area that is not capable of accepting such an operation. On the other hand, the surface of the touch panel device is not provided with such a structure. According to the configuration of the present embodiment, it is possible to assist the recognition of the position of the finger 30 without visual confirmation while maintaining the seamless degree in appearance of the surface of the touch panel device. In addition, since it is not necessary to add a vibration applying mechanism, a static electricity generating mechanism, or the like in order to assist the recognition described above, it is possible to suppress an increase in size of the user interface device 10.

The above advantage is particularly remarkable in a case where the user interface device 10 is installed in the vehicle 20. The displacement or vibration of the vehicle 20 tends to hinder the positioning of the finger 30 of the occupant relative to the operation accepting member 11. According to the configuration of the present embodiment, since the recognition of the position of the finger 30 for performing the operation involving contact can be assisted, the determination of the position of the finger 30 is facilitated. In a particular case where the operation accepting member 11 is operated by a driver of the vehicle 20, it is possible to suppress the driver's attention from being distracted from the driving.

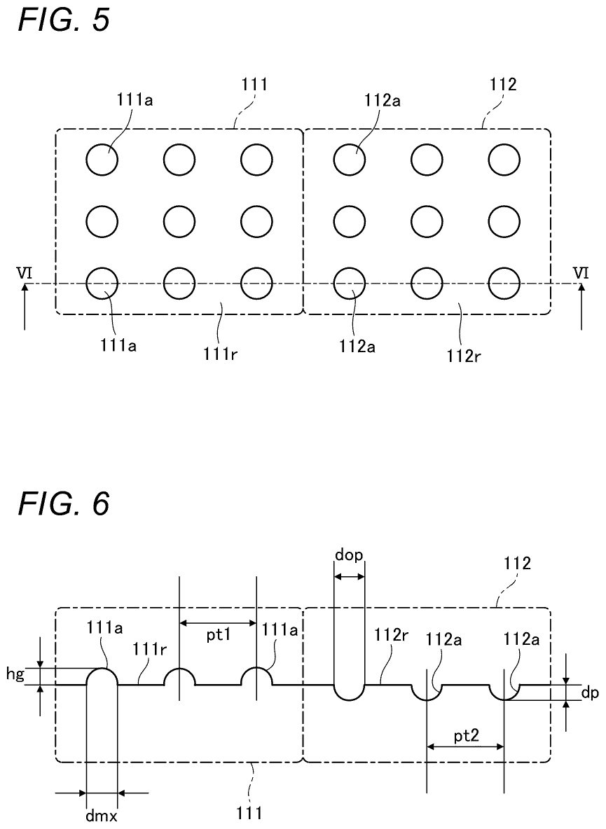

FIG. 5 illustrates another exemplary configuration of the operation accepting member 11. FIG. 4 illustrates another exemplary cross-section viewed from an arrowed direction along the line VI-VI in FIG. 5. Components common to those in FIGS. 3 and 4 are assigned with the same reference numerals, and repetitive descriptions for those will be omitted.

In this example, multiple concave portions 112a are formed in the second area 112. Each of the concave portions 112a has a shape having a curved side face so that the cross-sectional area thereof gradually decreases from the opened top toward the bottom. The concave portion 112a forms a surface of the operation accepting member 11 together with the second reference surface 112r. The concave portion 112a is a portion recessed from the second reference surface 112r.

According to the formation of the multiple concave portions 112a, when the occupant touches the second area 112 with the finger 30, a second tactile sensation that is different from the first sensation is obtained. In other words, the multiple concave portions 112a are so formed as to provide the second tactile sensation to the occupant touching the second area 112.

In accordance with the second tactile sensation to be provided, it is determined at least one of an opening diameter dop of the concave portion 112a, a recessed depth dp of the concave portion 112a, and an arrangement pitch pt2 of the multiple concave portions 112a. Each of the opening diameter dop, the recessed depth dp, and the arrangement pitch pt2 is an example of the shape parameter. The arrangement pitch pt2 is defined in a case where three or more concave portions 112a are arranged at equal intervals. The arrangement pitch pt2 is defined as a length of a straight line extending in a direction orthogonal to the normal direction of the second area 112 connecting the characteristic points of two adjacent concave portions 112a. In the example illustrated in FIG. 6, the center of the concave portion 112a viewed from the normal direction is determined as the characteristic point.

However, even in this example, the appearance of the second area 112 when viewed from the normal direction of the second reference surface 112r is the same as the appearance of the first area 111 when viewed from the normal direction of the first reference surface 111r. In other words, the shape of the concave portion 112a viewed from the normal direction of the second reference surface 112r is the same as the shape of the convex portion 111a viewed from the normal direction of the first reference surface 111r. Accordingly, the opening diameter dop, the recessed depth dp, and the arrangement pitch pt2 are determined with reference to the relationship with respect to the maximum diameter dmx, the protruded height hg, and the arrangement pitch pt1.

At least one of a ratio pr4 of the recessed depth dp to the diameter dm2, a ratio pr5 of the arrangement pitch pt2 to the diameter dm2, and a ratio pr6 of the arrangement pitch pt2 to the recessed depth dp may be used as a reference in determining the second tactile sensation.

The possible range of the ratio pr4 is the same as the possible range of the ratio pr1. The possible range of the ratio pr5 is the same as the possible range of the ratio pr2. The possible range of the ratio pr6 is the same as the possible range of the ratio pr3.

According to the configuration of the present example, it is possible to make the difference between the first tactile sensation and the second tactile sensation larger. In addition, it is possible to alleviate the strictness as for the direction from which the first area 111 and the second area 112 look the same. Accordingly, it is possible to further enhance the assistability for recognizing the position of the finger 30 without visual confirmation by the occupant, and to further enhance the seamless degree in appearance.

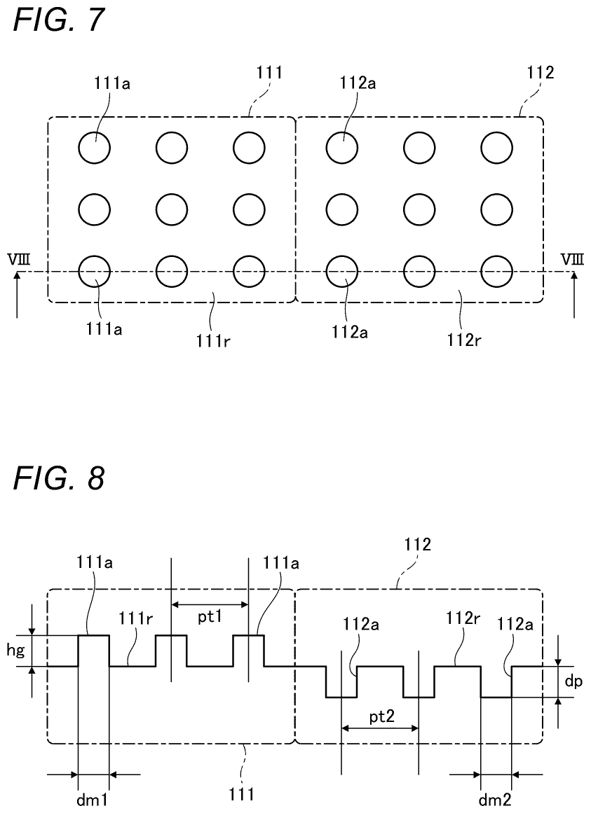

FIG. 7 illustrates another exemplary configuration of the operation accepting member 11. FIG. 8 illustrates another exemplary cross-section viewed from an arrowed direction along the line VIII-VIII in FIG. 7. Components common to those in FIGS. 5 and 6 are assigned with the same reference numerals, and repetitive descriptions for those will be omitted.

In this example, each of the multiple convex portions 111a formed in the first area 111 has a cylindrical shape. In this case, in order to determine the first tactile sensation, the relationship with at least one of the diameter dm1 of the convex portion 111a, the protruded height hg of the convex portion 111a, and the arrangement pitch pt1 of the multiple convex portions 111a can be used as a reference.

On the other hand, each of the multiple concave portions 112a formed in the second area 112 has a circular cross section. The diameter dm2 of the concave portion 112a, the recessed depth dp of the concave portion 112a, and the arrangement pitch pt2 of the concave portions 112a are determined such that the appearance of the second area 112 when viewed from the normal direction of the second reference surface 112r is the same as the appearance of the first area 111 when viewed from the normal direction of the first reference surface 111r. It should be noted that, as long as the appearance of the first area 111 and the appearance of the second area 112 are the same when viewed from the same direction, the second area 112 may be formed only with a flat second reference surface 112r, as in the example described with reference to FIGS. 3 and 4.

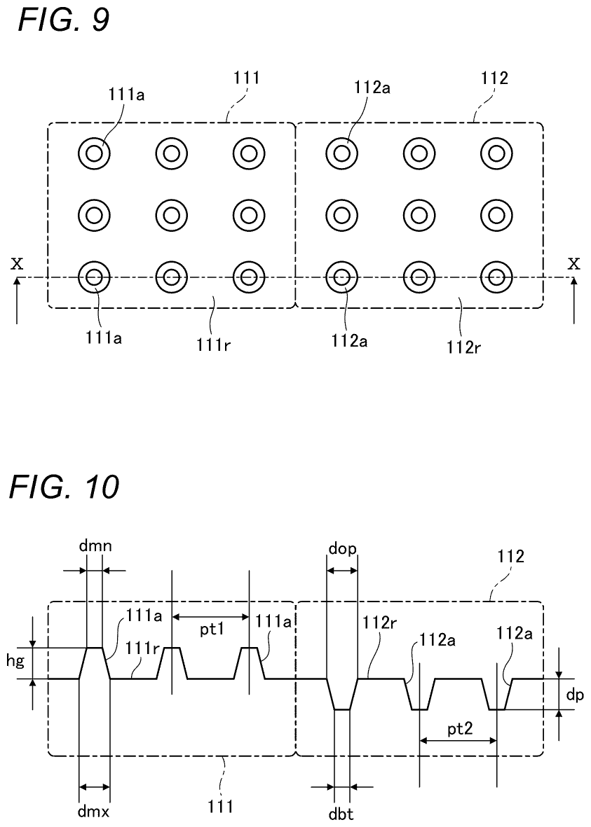

FIG. 9 illustrates another exemplary configuration of the operation accepting member 11. FIG. 10 illustrates another exemplary cross-section viewed from an arrowed direction along the line X-X in FIG. 9. Components common to those in FIGS. 5 and 6 are assigned with the same reference numerals, and repetitive descriptions for those will be omitted.

In this example, each of the multiple convex portions 111a formed in the first area 111 has a truncated conical shape. In this case, in order to determine the first tactile sensation, the relationship between at least one of the maximum diameter dmx of the convex portion 111a, a 30) minimum diameter dmn of the convex portion 111a, and a ratio of the maximum diameter dmx and the minimum diameter dmn, and at least one of the protruded height hg of the convex portion 111a and the arrangement pitch pt1 of the convex portions 111a can be used as a reference. The minimum diameter dmn is an example of the shape parameter.

On the other hand, each of the multiple concave portions 112a formed in the second area 112 has a shape in which the diameter gradually decreases from the opened top toward the bottom. The opening diameter dop of the concave portion 112a, a bottom diameter dbt of the concave portion 112a, the recessed depth dp of the concave portion 112a, and the arrangement pitch pt2 of the concave portions 112a are determined such that the appearance of the second area 112 when viewed from the normal direction of the second reference surface 112r is the same as the appearance of the first area 111 when viewed from the normal direction of the first reference surface 111r. The bottom diameter dbt is an example of the shape parameter.

It should be noted that, as long as the appearance of the first area 111 and the appearance of the second area 112 are the same when viewed from the same direction, the second area 112 may be formed only with a flat second reference surface 112r, as in the example described with reference to FIGS. 3 and 4.

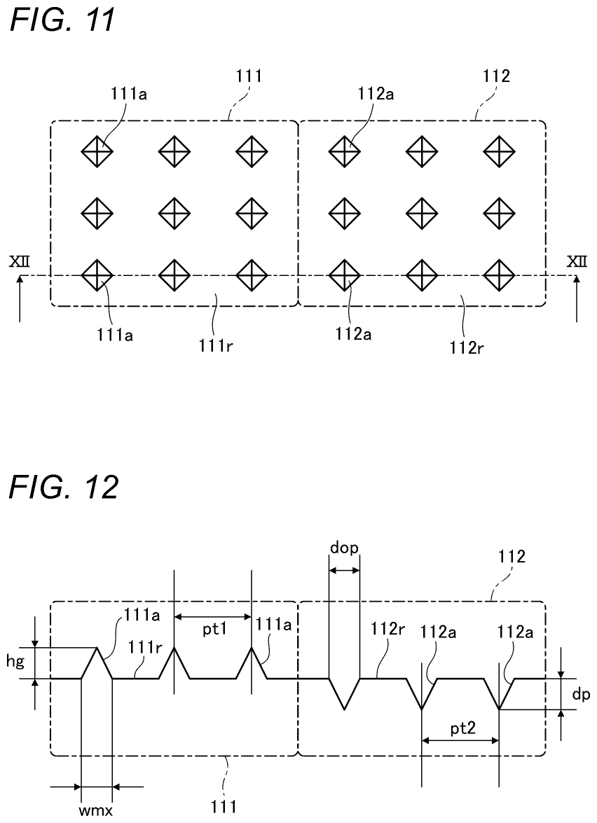

FIG. 11 illustrates another exemplary configuration of the operation accepting member 11. FIG. 12 illustrates another exemplary cross-section viewed from an arrowed direction along the line XII-XII in FIG. 11. Components common to those in FIGS. 5 and 6 are assigned with the same reference numerals, and repetitive descriptions for those will be omitted.

In this example, each of the multiple convex portions 111a formed in the first area 111 has a pyramid shape. In this case, in order to determine the first tactile sensation, the relationship between at least one of a length of the base of a triangular side face of the convex portion 111a, an inclination of the side face of the convex portion 111a, and a maximum width wmx of the convex portion 111a, and at least one of the protruded height hg of the convex portion 111a and the arrangement pitch pt1 of the convex portions 111a can be used as a reference. Each of the length of the base, the inclination, and the maximum width wmx is an example of the shape parameter.

On the other hand, each of the multiple concave portions 112a formed in the second area 112 has a shape having four side faces that are so inclined that a cross-sectional area gradually decreases from the opened top toward the bottom. A shape of the opened top of the concave portion 112a, the inclination of the side faces of the concave portion 112a, the recessed depth dp of the concave portion 112a, and the arrangement pitch pt2 of the concave portions 112a are determined such that the appearance of the second area 112 when viewed from the normal direction of the second reference surface 112r is the same as the appearance of the first area 111 when viewed from the normal direction of the first reference surface 111r. Each of the shape of the opened top and the inclination of the side faces is an example of the shape parameter.

It should be noted that, as long as the appearance of the first area 111 and the appearance of the second area 112 are the same when viewed from the same direction, the second area 112 may be formed only with a flat second reference surface 112r, as in the example described with reference to FIGS. 3 and 4.

Each configuration described above is merely illustrative for facilitating understanding of the presently disclosed subject matter. Each exemplary configuration can be appropriately modified or combined with other exemplary configurations described below:

In the above embodiment, the first area 111 and the second area 112 are disposed so as to share the boundary therebetween. However, the first area 111 and the second area 112 may be disposed so as to partially overlap each other. Alternatively, the first area 111 and the second area 112 may be separated by a structure forming a physical boundary. However, in this case, it is preferable that the distance between the first area 111 and the second area 112 is determined to such an extent that the finger 30 disposed at the boundary can straddle both the first area 111 and the second area 112.

As described above, in a case where the first area 111 and the second area 112 are adjacently arranged, even though they exhibit appearances with high seamless degree, it is possible to enhance a difference in the tactile sensation to be recognized by the user when the finger 30 contacts the first area 111 and the second area 112 simultaneously or sequentially. Accordingly, it is possible to provide the user with unpredictability that would be a commercial value.

However, as long as the appearances are the same when viewed from the distance and the angle at which the occupant normally uses the user interface device 10, the first area 111 and the second area 112 may be distant from each other.

In the above embodiment, only the multiple convex portions are formed in the first area 111. However, in order to provide the first tactile sensation, only multiple concave portions may be formed in the first area 111, or a combination of multiple convex portions and multiple concave portions may be formed in the first area 111.

In the above embodiment, only the multiple concave portions are formed in the second area 112. However, in order to provide the second tactile sensation, only multiple convex portions may be formed in the second area 112, or a combination of the multiple convex portions and the multiple concave portions may be formed in the second area 112.

As long as the appearances of the first area 111 and the second area 112 are the same when viewed from the same direction, at least one of the convex portion and the concave portion included in each area can be formed so as to exhibit multiple types of shapes.

In the above embodiment, the appearance of the first area 111 viewed from the normal direction of the first reference surface 111r is the same as the appearance of the second area 112 viewed from the normal direction of the second reference surface 112r. However, as long as the appearances of the first area 111 and the second area 112 are the same when viewed from the same direction, the direction can be appropriately determined in accordance with the locational relationship between the user interface device 10 and the user during the normal use. For example, as long as the appearances of the convex portion 111a and the concave portion 112a are the same when viewed from that direction, the shape of the convex portion 111a viewed from the normal direction of the first reference surface 111r and the shape of the concave portion 112a viewed from the normal direction of the second reference surface 112r may be different from each other.

In the above embodiment, the operation accepting member 11 is provided as a part of the touch panel device. The detector 12 detects a touch operation by detecting a change in electrostatic capacitance caused by contact of the finger 30. However, the detector 12 may detect the touch operation by detecting a change in pressure caused by the contact of the finger 30.

Alternatively, the operation accepting member 11 may be provided as a part of a mechanical switch device that is moved by an operation involving contact of the finger 30 of the occupant. In this case, the detector 12 is configured to detect the operation by detecting the movement of the operation accepting member 11.

The user interface device 10 may be installed in a mobility other than the vehicle 20. Examples of such mobilities include railways, aircrafts, and ships.

The user interface device 10 need not be installed in a mobility. The user interface device 10 can be installed in an appropriate house facility or a home electric appliance for which an operation involving contact by a user is required in order to perform an operation control of the controlled device.

The configuration equipped with the first area 111 and the second area 112 capable of exhibiting different tactile sensations need not be installed in a user interface device configured to detect of an operation. For example, the first area 111 and the second area 112 may be formed on a surface adapted to be touched by a user's finger in an education toy or a care equipment, thereby assisting recognition of multiple elements having different attributes. The education toy and the care equipment are examples of the tactile sensation exhibiting article.

The present application is based on Japanese Patent Application No. 2021-164877 filed on Oct. 6, 2021, the entire contents of which are incorporated herein by reference.

1. A user interface device, comprising:
an operation accepting member including a first area and a second area; and
a detector configured to detect an operation of a user involving contact with respect to the operation accepting member;
wherein at least one of a concave portion and a convex portion configured to provide first tactile sensation to the user is formed in the first area;
wherein the second area is configured to provide second tactile sensation that is different from the first tactile sensation to the user; and
wherein an appearance of the first area and an appearance of the second area are the same when viewed from the same direction.

2. The user interface device according to claim 1,
wherein at least one of a concave portion and a convex portion configured to provide the second tactile sensation is formed on a surface of the second area.

3. The user interface device according to claim 2,
wherein a value of at least one shape parameter defined for at least one of the concave portion and the convex portion in the first area matches a value of at least one shape parameter defined for at least one of the concave portion and the convex portion in the second area.

4. The user interface device according to claim 2,
wherein a ratio of multiple shape parameters defined for at least one of the concave portion and the convex portion in the first area matches a ratio of multiple shape parameters defined for at least one of the concave portion and the convex portion in the second area.

5. The user interface device according to claim 1,
wherein the first area and the second area are adjacently arranged.

6. A tactile sensation exhibiting article, comprising:
a first area in which at least one of a concave portion and a convex portion configured to provide first tactile sensation to a user is formed; and
a second area in which at least one of a concave portion and a convex portion configured to provide second tactile sensation that is different from the first tactile sensation to the user is formed,
wherein an appearance of the first area and an appearance of the second area are the same when viewed from the same direction.
